(19) United States
(12) Patent Application Publication
(10) Pub. No.: US 2002/0026256 A1
(43) Pub. Date: Feb. 28, 2002

(54) Global virtual audio production studio

(76) Inventor: Georgia Hilton, New York, NY (US)

Correspondence Address: Philip M. Weiss, WEISS & WEISS, 500 OLD COUNTRY ROAD, GARDEN CITY, NY, 11530, US

(21) Appl. No.: 09/978,903

(22) Filed: Oct. 16, 2001

Related U.S. Application Data
(63) Continuation of application No. 09/578,612, filed on May 25, 2000.

(51) Int. Cl. G06F 17/00; G10L 11/00

(52) U.S. Cl. 700/94; 704/270

(57) ABSTRACT

The apparatus relates to tying together multiple acoustically and technologically identical facilities.

### RELATED APPLICATIONS

This application is a continuation of U.S. application Ser. No.: 09/578,612 filed May 25, 2000.

### FIELD OF THE INVENTION

The present invention relates to tying together multiple acoustically and technologically identical facilities.

### BACKGROUND OF INVENTION

The information, telecommunications and entertainment markets and industries are undergoing great change, as a result of a phenomenon that started in recent years. We have witnessed the convergence of technology sectors and traditionally different market segments such as telecommunication, information technology, the media and entertainment.

This convergence corresponds to a combination of information, creative, technology, and various synergies, leading to the availability of innovative services and multimedia applications. Communications, data access, creative efforts, information flow, and multimedia development are changing rapidly. The digitizing of information, most of the time in analog format, and also advanced capabilities of information processing, compression and storage, enable today's user to access this information in a much more effective and timely manner. Audio Production within the entertainment field, technology field, and corporate fields has changed and is moving with this new information flow. Today, scheduling, travel, and coordination are often difficult if not impossible to accommodate.

U.S. Pat. No. 5,283,639 relates to a multiple media delivery network method and apparatus having a central site and a remote site for customizing video and audio presentations comprising a communications channel, a studio processor, a scheduling processor, a network processor, a transmitter, a communications processor, a video processor, and optionally a matrix switch, cue processor, a matrix switch processor and a system monitor. Specifically, the invention relates to television advertising systems and to a communications distribution system which allows customizing the video presentation at each ground terminal.

U.S. Pat. No. 5,365,579 relates to a method and apparatus for remote control and synchronization allowing for simultaneous remote collaboration. The system of the invention includes a sending studio where a motion picture soundtrack is produced and a receiving studio where the motion picture is viewed while the soundtrack is transmitted from the senior studio. The system includes communications terminals at both the sending and receiving studios which can translate analog audio-image synchronization and other control or communications signals into an encoded digital signal suitable for long distance transmission and reconstruction without signal loss or serious distortion. The encoded digital is transmitted from one signal studio to another for control and synchronization of the audio and video equipment used to produce the motion picture soundtrack.

U.S. Pat. No. 4,868,682 relates to a method of recording and reproducing video and sound information using plural recording devices and plural reproducing devices. An original space in which video and sound information are to be recorded is divided into plural sections. A video recording device and a corresponding sound recording device are provided for each section of the original space. A reproduction space in which video and sound information are to be reproduced is divided into plural sections corresponding to the plural sections of the original space. Synchronous operation of plural video reproducing devices is performed simultaneously with synchronous operation of plural sound reproducing devices so that the picture and sound of each section of the original space are reproduced simultaneously in a corresponding section of the reproduction space.

### SUMMARY OF THE INVENTION

The present invention ties together multiple acoustically and technologically identical facilities. It is an object of the present invention to vastly reduce the problems of sound being heard differently in different places because the acoustics of the rooms in which the sound is heard is different. It is an object of the present invention to shorten the time-to-market it takes to produce an audio recording while reducing cost.

The present invention provides acoustically identical rooms across local and remote facilities. It is an object of the present invention to provide acoustically identical monitoring systems. It is an object of the invention to provide identically configured Digital Audio Workstations and/or Audio Production Editing stations. It is an object of the invention to provide interconnected network based audio processing equipment. It is an object of the present invention to provide identical mixing consoles/tactile work surfaces. It is an object of the present invention to provide identical audio processing systems. It is an object of the present invention to provide centrally managed network based storage system within each facility for audio and video data. These storage arrays are then interconnected via the Matrix Network. It is an object of the present invention to provide synchronized playback between facilities. It is a further object of the invention to provide a system with high bandwidth data transfers for extremely fast bulk data transfers.

It is an object of the present invention to provide an audio space comprising;

an acoustical enclosure, an acoustical treatment to the enclosure, interconnections for all necessary cabling to operate audio and video equipment within the enclosure, the audio space having the ability to be duplicated, while ensuring acoustical specifications are adhered to.

It is a further object of the present invention to provide one or more audio spaces having interconnection between the audio spaces, a machine room, multiple digital audio workstations (DAW), multiple tactile control surfaces for the DAW, multiple audio mixing consoles, multiple audio processors, and central audio/video storage facility (CAVS).

It is a further object of the present invention to provide an audio space having a Local Area Network to support interconnection and inter -communication between the audio spaces, DAWs, CAVs, and other audio and video equipment.

The present invention provides Duplicated Audio processing equipment, identically configured to provide exactly matched capabilities inter and intra facilities comprising;

identically configured DAW systems;

identical tactile work surface systems;

matched audio consoles providing for IP or other network connectivity allowing for shared console activities locally and/or remotely;

tightly coupled consoles allowing for ganging and interaction for various sized audio processing projects and network coupling of remote devices;

identical IP and Non-IP based audio processing systems, allowing for remote operations on a local audio processing effort. The system of the present invention further provides for the ability to interconnect tactile work surfaces allowing the assignment of discrete components to be remotely manipulated and assigned from and to any facility.

The duplicated audio mixing and editing work surface of the present invention further comprises network based audio editing workstations coupled to network based tactile work surfaces;

an apparatus allowing for fader control and/or other audio processing controls on one or more tactile work surfaces or audio mixing consoles to be operated remotely and/or locally between facilities.

The present invention further provides the duplicated audio processing equipment further comprising;

a Local Area/Wide Area Network configured to assure bandwidth requirements between multiple DAW (digital audio workstations) and their associated tactile work surfaces within a single facility or across a Wide Area Network to remote facilities comprising;

high-speed routers;

network hubs;

physical network cables;

interconnections to third party networks;

interconnections to the World Wide Web and Internet connectivity;

audio and video content servers in support of all DAW systems and mixing consoles.

It is a further object of the present invention to provide duplicated audio processing equipment comprising;

a Local Area/Wide Area Network configured to provide switching capability between all local DAW systems and all local tactile work/control surfaces internal to a single facility and/or across the network to multiple remote facilities comprising;

high-speed routers

network hubs

physical network cables;

interconnections to third party networks;

interconnections to the World Wide Web and Internet connectivity;

audio and video content servers in support of all DAW systems and mixing consoles.

It is an object of the present invention to provide a Local Area/Wide Area Network configured to provide high-speed thruput to accommodate audio and video data from a central content management system to any local DAW system or mixing console internally in a single facility and/or across a network to remote facilities.

It is a further object of the present invention to provide a Local Area/Wide Area Network comprising;

one or more fiber or other high-speed network based audio and video content servers;

redundant servers providing redundant data paths to all DAW systems (as required);

management console providing monitoring and management of all Servers on the network.

It is a further object of the invention to provide a Local Area/Wide Area Network comprising;

a central storage apparatus capable of transmitting and duplicating local content across a Wide Area Network to similar Central Storage apparatus at other networked facilities.

It is an object of the present invention to provide an apparatus such as a multiplexer/demultiplexer and/or compression apparatus to encode and decode audio data streams sent externally from one facility to any or all other facilities as a point to point data stream.

It is an object of the present invention to provide an apparatus to support multiple synchronized encoded and decoded audio data streams sent externally from one facility to any or all other facilities as a point to point data stream.

It is an object of the present invention to provide an apparatus to encode and decode audio data streams sent externally from one facility to multiple facilities as a broadcast data stream.

It is an object of the present invention to provide an apparatus to support multiple synchronized encoded and decoded audio data streams sent externally from one facility to multiple facilities as a broadcast data stream.

It is an object of the present invention to provide an apparatus to support multiple synchronization of local video data locked to incoming encoded and decoded audio data streams sent externally from one facility to any or all other facilities as a point to point data stream.

It is an object of the present invention to provide an apparatus to support multiple synchronization of local video data locked to incoming encoded and decoded audio data streams sent externally from one facility to multiple facilities as a broadcast data stream.

It is an object of the present invention to provide an apparatus providing for any DAW system to connect to any compatible tactile interface located on the network.

It is an object of the present invention to provide an apparatus providing for timing and control for synchronizing audio playback between any facility room with any other facility room providing for local synchronization and remote synchronization inter and intra facilities.

It is an object of the present invention to provide an apparatus to interconnect a network of the present invention with another network of the present invention, and to provide for third-party network connectivity.

### BRIEF DESCRIPTION OF THE DRAWINGS

FIG. 1 illustrates basic network connectivity between local DAW and remote worksurface.

FIG. 2 illustrates a basic local area network of the present invention.

FIGS. 3a and 3b illustrate a DAW local tactile worksurface connectivity of the present invention.

FIG. 4 illustrates a world wide system of the present invention using an internal data network comprised of a private telecommunications high speed network, Internet connectivity, and other third party interconnectivity.

FIG. 5 illustrates a facility conceptual layout of the present invention.

### DETAILED DESCRIPTION OF THE INVENTION

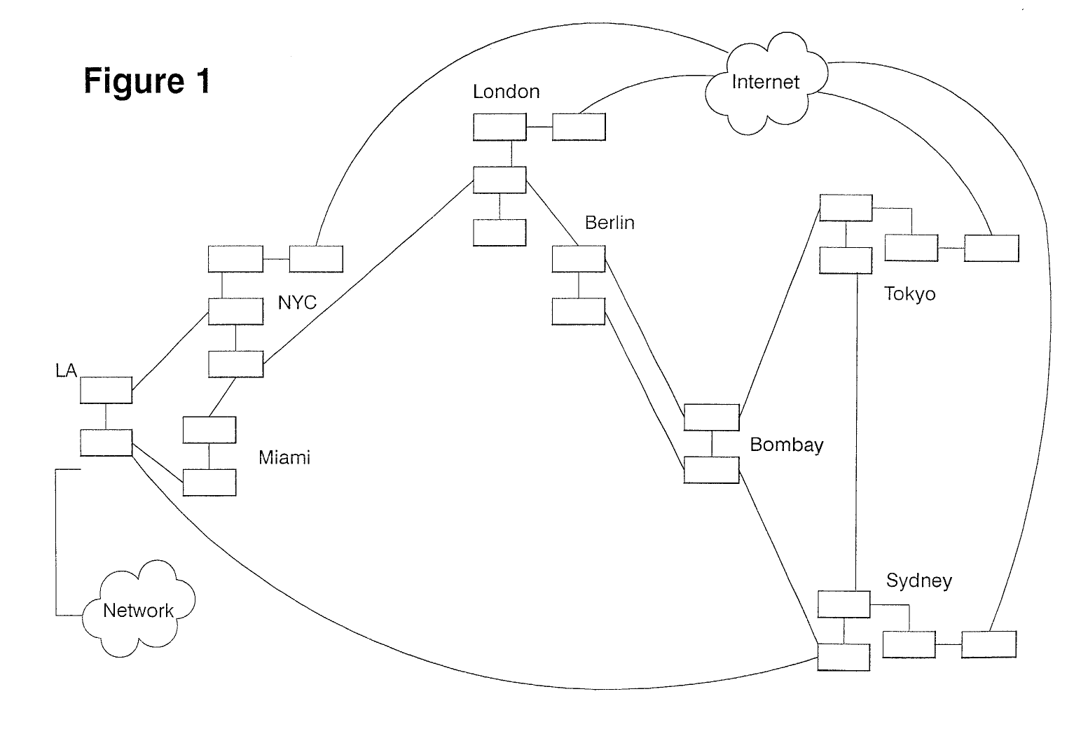

In one embodiment of the present invention illustrated in FIG. 1, the Director is on-location in Sydney. The Producer is meeting with the Studio in LA, the Supervising Sound Editor is in New York recording with the Sound Design Team. The Second-unit team is in Tokyo. All this while ADR is occurring in London. Travel costs are mounting, time is being lost every day. The Sound Crew, the talent, the producers are listening and the director is listening. The Artists and Engineers are listening. The present invention provides a system so that each of these persons located across the globe can be listening to the same exact audio production.

### Design Overview

The present invention is the marriage of Fiber Networks/ISDN/International high-speed network technology with State-of-the-art digital audio technology to create a single global virtual audio production facility.

The Global Virtual Audio Production Studio of the present invention, provides a set of physically, acoustically and technically identical multi-site Audio Production facilities working together as if they were in-fact, one studio in one location. This allows audio production and audio post-production sessions to function in various diverse locations in a single united effort. All personnel located in any given studio will hear and be able to respond to audio created, edited, mixed or otherwise manipulated in any other site. During this response/session it is assured that all personnel hear exactly the same audio information and therefore are offered an exact re-creation of the original sound source at the selected “master” site. Consoles and/or audio workstations may be interconnected in a tightly coupled or loosely coupled configuration allowing for real-time local and remote editing/mixing of a single project.

Every Facility of the present invention is designed and built to exact standards and specifications -physically, acoustically and technologically. All studios provide identical Digital Audio Workstations (DAW), and identical tactile work surfaces. All studios provide identical audio and video monitoring systems. Since each and every site is identical in nature and audio processing equipment is tightly coupled via IP or other network technology, any audio projects may be created, manipulated, and/or transferred, at will, to and from any site within the studio, with complete abilities to re-create any project in any site within minutes. Additionally, audio may be “broadcast” to any and all sites to enable “playback” sessions for review and comment, without the need for all parties to be co-located in one studio, in one city.

The studio of the present invention also allows for growth via, certification and implementation of client “in-house” facilities, new general use locations, and expansion of any pre-existing studio locations. All facilities MATRIX, Multi-Audio Transmission and Interaction Extension are interconnected via three diverse routes.

Internal MATRIX

Internet

Ednet and/or other specialized Audio Production network

The present invention's audio production facilities may be added vertically or horizontally. Each existing facility may have additional rooms added, or new facilities may be added to the MATRIX. The present invention creates a matrix of TDM Busses, High Speed LANs, and High-speed WANs to create a global audio production environment.

The facilities of the present invention may be implemented in various configurations ranging from a small remote system, SR, large remote system, LR, core system, or extended facility. The system of the present invention has acoustically identical rooms across the local and remote facilities.

In a preferred embodiment the system of the present invention has:

acoustically identical monitoring systems;

identically configured DAW systems;

identical mixing consoles;

a network based DAWs and identical tactile work surfaces;

identical audio processing systems;

centrally managed network based storage system within each facility for audio and video data;

interconnected storage systems over the Wide Area Matrix Network;

synchronized playback between facilities; and

high bandwidth data transfers for extremely fast bulk data transfers.

The facilities of the present invention are all interconnected to provide the first Global Virtual Audio Production Studio in the World. The system of the present invention includes multiple Audio Production Facilities featuring tightly coupled acoustically identical recording, editing and mixing rooms, in which audio may be edited, recorded or mixed locally and/or remotely while review and adjustments are made remotely from another of the duplicated facilities, assuring exact acoustical treatment and exactly duplicated listening environments.

In a preferred embodiment, all rooms in all facilities will have effectively identical audio processing capability, identical monitoring systems, identically configured Digital Audio workstations, and identical control surfaces, and tightly coupled interconnectivity.

Each duplicated facility provides for centrally managed Audio and Video data tied to a Local Area and Wide Area Network connecting multiple Digital Audio Workstations together as a single virtual audio editing system, both Intra-studio and Inter-studio. Personnel may utilize local and remote systems coupled to allow audio processing on local and/or remote equipment, consoles, and support equipment.

Equipment may be assigned to local session and/or remote sessions via network connectivity between major components in all matched facilities. In a preferred embodiment the facilities provide for Video teleconferencing between sites to allow for smooth interaction between audio production teams at various sites.

The audio may be recorded, edited and mixed from one or many sites simultaneously or transferred via the high-speed network interconnections for remote manipulation. All studios are linked to allow for encoded audio signals, video signals, timing and control signals.

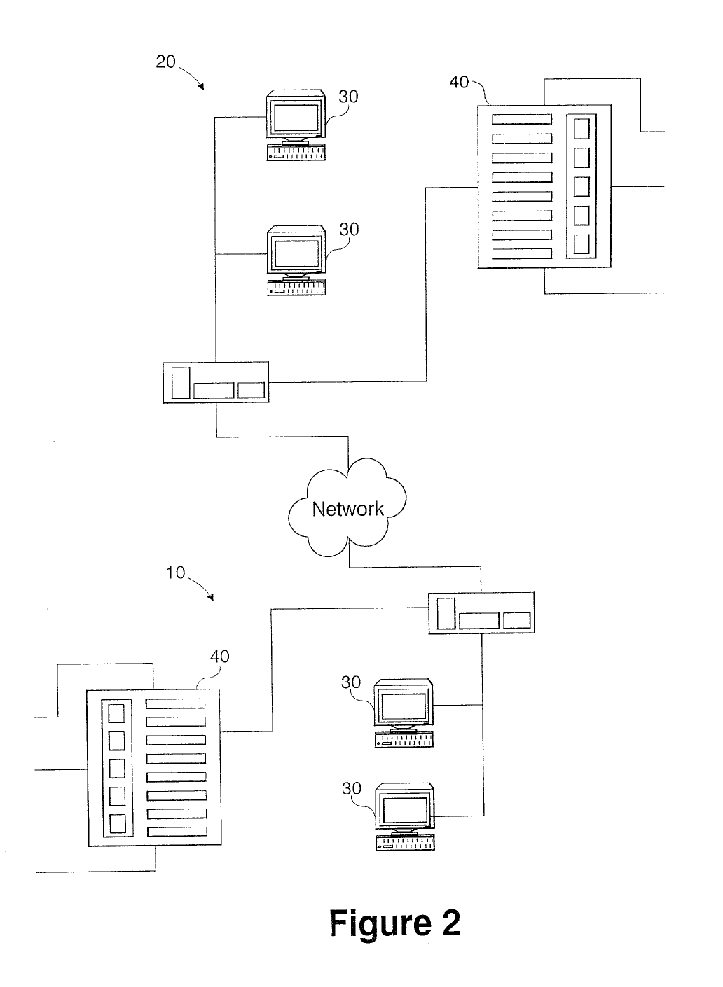

FIG. 2 shows a basic path between two acoustically and technologically identical Global Virtual Audio Production Sites 10 and 20 with local and remote access for both audio workstations 30 and tactile work surfaces and/or consoles 40. Any networked Digital Audio Workstations networked Audio Processing Device may connect to any networked Tactile Work surface within the globally implemented network of the present invention.

The facilities of the present invention will attempt at all time to adhere to SMPTE Advanced Systems Control Architecture (ASCA). The facility implementations will attempt to adhere to all NTSC, AES, IEEE and other international standards, as applicable to the implementation of the present invention.

### USE of Various Digital Mixing/Editing Platforms Within the Present Invention

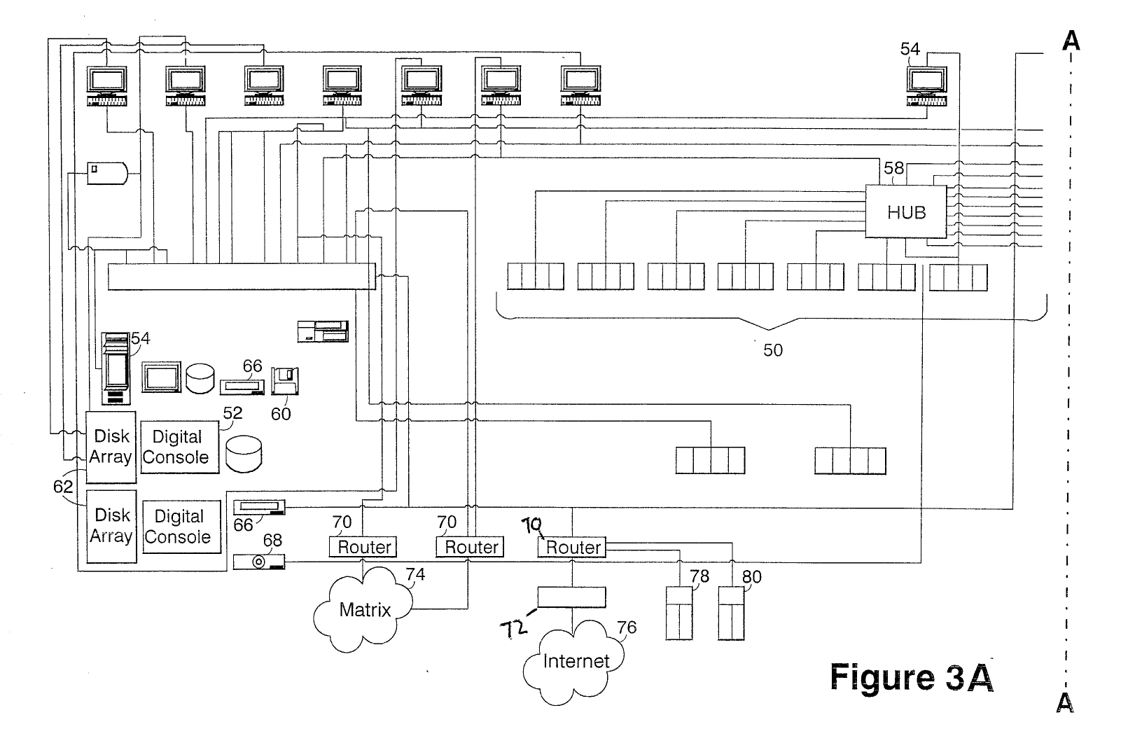

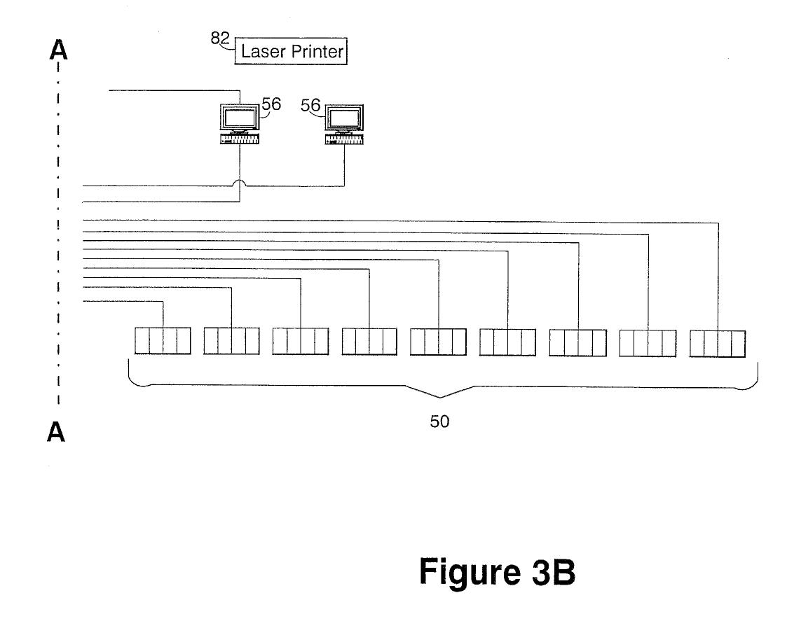

FIGS. 3a and 3b illustrate a basic local area network of the present invention. In a preferred embodiment, the Protools 24|Mix is used, but any digital console 52 capable of meeting the criteria described in the present invention may be utilized in place of Digidesigns' Protools work stations, or in conjunction with Protools or other Audio Editing Workstation. Master and Fader units 50 are connected through a hub 58. The Protool Units are connected to an Avid system 54. Also shown is an Office PC 56, Removable storage 60, Disk Array 62, NT Server 64, Tape Drive 66, Optical Drive 68, Router 70, Firewall 72, Matrix 74, Internet connection 76, Mail Server 78, Web Server 80 and Laser Printer 82. The present invention gives the ability to tightly couple any digital audio platform to/from remote locations while maintaining acoustical and technology transparency.

### Capabilities

In a preferred embodiment, the system of the present invention provides:

a Real Time Remote Multi-site Multi-Channel Audio Recording & Mixing;

high-Speed Audio/Video Data Transfers/Conversions;

film/Video/Broadcast Recording and Mixing for HDTV and Analog TV;

Multi-Channel Audio Format Recording and Mixing;

5.1, 7.1. DTS™, SDDS™, THX™, Surround Capabilities;

inter-connection Network Services for any studio;

video/Audio Teleconferencing in the Studio and Conference space;

virgin Audio from start to finish in one format—all digital;

from location to the Theater in Digital;

shared Audio and Video data Globally.

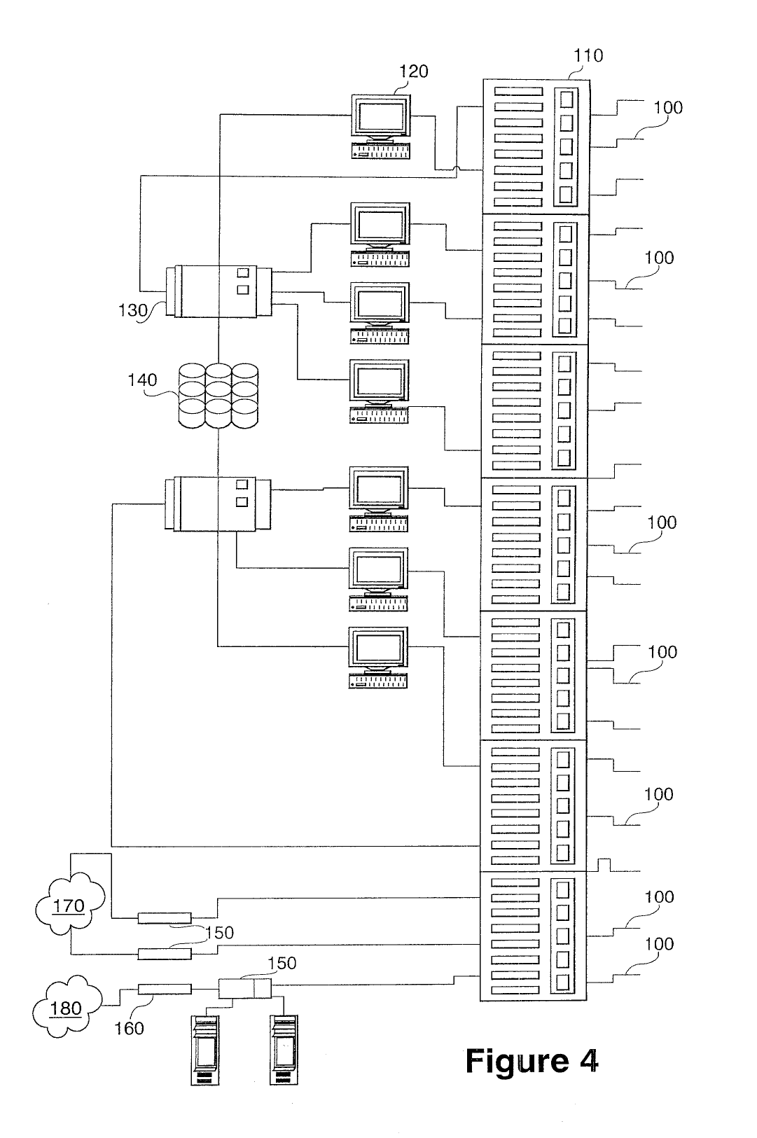

FIG. 4 illustrates a DAW/Local tactile worksurface connectivity. Tactile Control Surfaces 100 are connected to Hubs 110 which are connected to Workstations 120. Workstations 120, are interconnected by a disk array 130 where the data is stored 140. The system contains Routers 150 and a Firewall 160. The system forms a Matrix 170. The system can be connected to the Internet or third party Networks 180.

In a preferred embodiment, each facility of the present invention is completely digital; all sound elements are retrievable from high-speed servers for fast access. By utilizing standards and identical facilities, the present invention avoids typical problems of system incompatibility. The advanced editing, real-time processing and automation features of the Digital Audio Editing platforms allow for performance that no other system can provide. The real benefits of having a flexible, integrated DAW (digital audio workstations) are the time they save for the facility and the results it can turn around for the client. Time-to-Market reductions saving Cost-of-Money and bridging the client product to market faster. Integrated DAW systems running over an internal network, sharing data on a solid data warehouse system allows tremendous creative options for clients in real time.

Additionally the present invention will allow for large remote and small remote facilities offering the ability for on-demand on-location recording/editing and mixing.

The system of the present invention provides an editing/playback system capable of providing pre-recorded playback, recording and editing in real time with full synchronization capability. Not only will the initial first generation audio be used in the final mix, the data can be transmitted in full over high-speed communications or other Internet based data transmissions to the Post facility while the crew is still breaking down the shoot. The Audio will be on the sound stage, in the correct format, with time code sync, by the time the crew finish their coffee break.

This new audio chain capability, as well as, support for existing methods will provide for first generation audio to be recorded digitally on-site at the filming locations, transferred on high-speed data links via cellular modem, landline, or simply sent by messenger to the nearest facility having the specifications of the present invention. The audio will never be the critical path until the final mix. Audio operations can occur in real time and be handled in a parallel processing manner, vastly reducing cost, errors, time and improving overall audio quality for services such as:

Audio for Film/Video/Broadcast (HDTV, TV, Digital Video, Analog Video, Film);

ISDN/Frame relay/Ethernet/Fiber Optic /Internet/Internal Network Services;

Audio Recording/Mixing;

DVD 5.1 & Surround Sound Mix and Re-Mix;

Foley/Sound Effects;

ADR and Dialogue Editing;

Conversion/Duplication/Transfer;

Web development and Web Audio;

Studio Technology;

Broadcast Support;

Video Editing/Audio Support for Video;

In a preferred embodiment all sites will be designed and implemented with identical configurations including identical:

1. Internal Room designs

2. Building materials

3. Equipment & placements

4. Configuration

5. Out-board gear

6. Mixing Desks

7. Monitor selection and implementation

8. Software implementation and version management

9. Back-office systems and machine rooms

### Architecture

In a preferred embodiment, the architecture of the present invention is structured into Three layers:

Application Layer

Service Layer

Device Layer

The architecture utilizes the SMPTE ASCA functional planes as a model, but unlike the SMPTE model, these layers manage and understand the facility configuration of the present invention and function to provide a single user interface globally.

### Application Layer

The Application layer manages and handles the actual Audio and Video Content used in the creation of a product for the project. Digital Editing software, hardware, Digital mixing consoles and other devices that actually manipulate Audio are managed in the application layer.

### Service Layer

The Service layer provides network services to the Application Layer. As any given Application layer device or application requires access to audio data, the Service layer provide connectivity to the audio and video data from the Device Layer to the Application layer. It also provides the layer in which networking and IP services reside. The Service layer provides interconnectivity to third party systems and to the proposed SMPTE standards for Advanced System Control Architecture. The Service layer also provides for MPEG, NTSC, PAL, SECAM, (all other audio standards), and other timing issues required to resolve real-time streaming audio and SMPTE.

### Device Layer

The Device layer provides the physical connectivity and actual hardware device data for all DAWs, digital consoles, storage devices, and audio processing equipment. The device layer provides the interface between physical hardware and the Service Layer. These three layers provide for a straightforward implementation and management methodology for a network of the present invention.

In a further embodiment, the Global Virtual Audio Production Facility MATRIX network consists of a local site LANs and a single WAN. The WAN will consist of three major sections. The MATRIX resides in the Architectural Service Layer.

Internal WAN Above-Net Fiber optic network

Internal LAN Fiber Network

External Internet Connectivity

External Ednet/RocketNet/misc. other specialized Audio networks.

These three sections of the MATRIX allow for audio data, teleconference, video/teleconference and Video data to be linked/utilized/and or data transferred between all facilities in Real-time or Bulk transfer modes. Routers and hubs support the LANs and their interconnectivity via the WAN MATRIX. Depending on requirements, the facilities may be set up via Satellite, Internet, ISDN, or Ednet for temporary configurations and low-level data transfers.

The MATRIX of the present invention may be extended and modified at will. The MATRIX may utilize any and all types of network methodologies depending on bandwidth requirements and project budgets. The MATRIX network allows the intercommunications to occur between local LANs and their associated TDM buss technology based Audio Editing Workstations, IP based Tactile work surfaces, IP based audio processing units and Digital Audio editing/mixing consoles.

The MATRIX network allows for any and all sites to communicate, including internal facilities, core Customer facilities, and Remote facilities such as trucks, on-site location, and temporary trailers.

### MATRIX LAN

In an embodiment, the LAN (Local Area Network) in part of the Service Layer consists of Audio Workstations, IP based digital tactile mixing consoles, non-IP based digital audio consoles, IP based Audio Processing systems, back office servers, routers, switched Ethernet hubs, and Fiber-optic based RAID technology Disk sub-systems. Each room of the present invention utilizes both Switched Ethernet and Fiber technology to maintain connectivity with all other local and remote rooms for general messaging, data transmission, and actual Audio/Video client data. The switched Ethernet acts as the central carrier for general office data and interconnectivity of DAW (digital audio workstations) with any local or remote tactile work surfaces. The actual Audio data and video data is accessed locally via the internal Fiber network at each site.

### MATRIX WAN

In one embodiment, the MATRIX WAN (Wide Area Network) is part of the service layer and interconnects the facilities. Each facility is initially linked by highspeed Telecommunications utilizing Above-Net fiber network technologies, offering services such as the following: Real time and/or streaming Audio; Video Teleconferencing and Video Picture; Direct Voice Communications; Systems control and remote operation via Ethernet; Data Transfer for bulk data; and Data Transmissions project data.

In a preferred embodiment, every identical facility is linked to all other facilities by:

High-Speed/Transparent Network;

Raid Disk Technologies for Audio and Video data;

Audio/Video/Telecomm/Data/Sync;

Fiber optic Data communication internal to each facility;

100 Mb Switched Ethernet;

Full Dual-path Redundancy (routers/Firewalls);

Encryption/Security;

High-Speed Internet Connectivity with Firewalls and Security Systems; and

Internet, Ednet™, RocketNet™ and other Media network connections.

### Site Configuration Overview

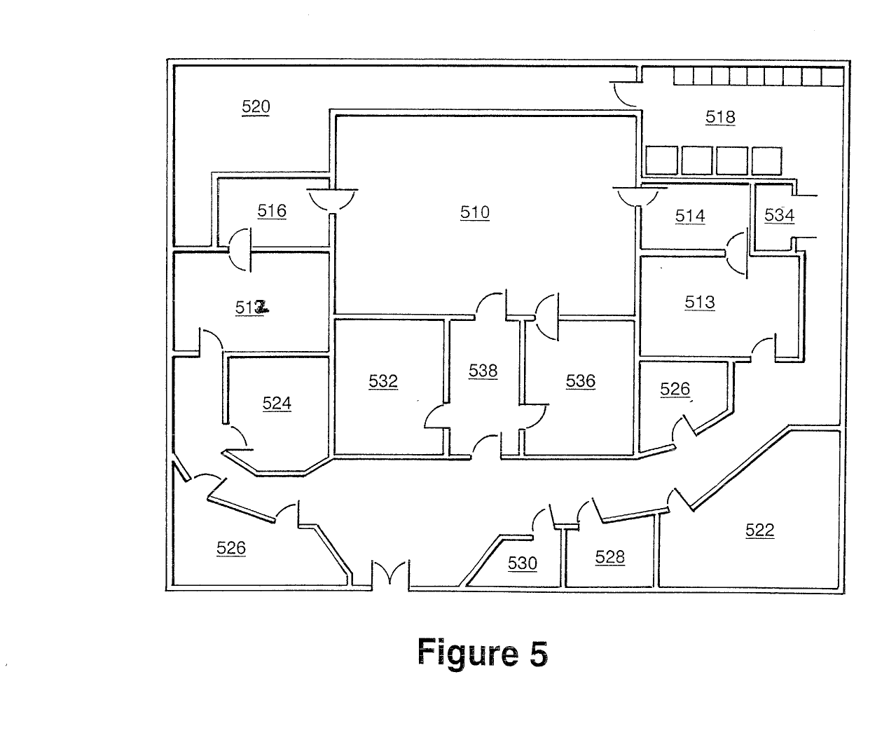

In a preferred embodiment as shown in FIG. 5 each Site will consist of a main mix suite 510, audio editing suites 512, a secondary recording and video editing suite 513, shared recording spaces, an ADR 514, and Foley Recording Space 516. Additionally, facilities will be equipped with a machine room 518, digital storage facility and library 520, client spaces including kitchen 522, conference room 524, office spaces 526, bathroom 528, reception 530, AVID suite 532, telecom closet 534, studio 536 and sound lock 538. More concisely, the studio will consist of:

4 Seat, 4 Stem Fully Integrated Computer Based Digital Mixing Facility

5.1 Surround Sound & Multi-channel Format capability

HDTV and Analog TV Audio Production

Network Connectivity/Remote Production

Kind-of-Loud™

THX™ Certification (Lucas Films)

Dolby E technology (Dolby E™)

Dolby Surround™

DTSTM, SDDS™, THM™,THX™ certifications and capabilities

HDTV and Analog Video capabilities

6 Protools based editing/mixing stations

1 Avid Non-Linear Video Editing Room

Video/Teleconferencing & Conference Room w/5.1

Machine Spaces/Office Spaces/Client Space

All Studio sites will have on-demand telecommunication capability for location and remote audio recording with on-site editing and immediate downloading of audio data back to the local studio site.

### Main Suite

In a preferred embodiment, the standard main audio mixing suite will consist of systems interconnected via Ethernet and utilizing tactile control surfaces providing for extensive mixdown and editing capability. All systems will be interconnected to a central digital storage facility via fiber optics. The main suite will provide mono, stereo, surround sound, DTS, Dolby, THX, 5.1,7.1 mix capacities and formats. The main suites will provide extensive outboard analogue and digital equipment to support a film mix. Video capability will include theater screening via projection or HDTV and local flat panel displays as required for each project.

Each console allows non-linear editing and mixing, and can go offline or online at any time without affecting the rest of the mix. The present invention has automation built in, instead of printing interim sub-mixes, it provides the ability to automate from the beginning of the reel all the way to the end. There will be no rendering until the final playback. This reduces time to market and cost. Each facility will have the ability to manage multiple film projects and jump between mixes at any station, in any studio, at anytime. Recall and re-mix take a few minutes to re-create instead of days.

MIX 1 is configured and cabled to allow consoles to be installed and configured within 1 to 2 hours.

Different or specialized consoles may be placed in any of the facilities. If a given project is to be local, one console may be swapped out. If the project will span various locations, then each location will require an identically configured console.

In one embodiment, four linked Pro Tools|24 MIXplus™ workstations in Mix 1 room:

1. Station 1: Dialogue (stem)

2. Station 2: Music (stem)

3. Station 3: SFX/Foley (stem)

4. Station 4: Records the previous three stems and creates its own 5.1 mix

Further components include:

1. Total of 32 faders per system linked to provide 128 fader operation

2. Full Clock synchronization within the facility and across the MATRIX.

3. Total of 192 tracks with many more virtual tracks for alternate mixes at each site in the main room alone. Additional capability can be added to major projects by tying in all edit bays and secondary rooms.

4. High-end A/D D/A converters

5. State-of-the-art clock and black burst system

6. State-of-the-art video/audio sync

7. Extensive software based plug-ins

### Audio Editing Suite

In an embodiment, the recording spaces and audio/video suites will contain 1 Protools 24|mixplus systems inter-linked and operating from a Procontrol tactile work surface. Again, all systems tie back to the central digital storage array via fiber optic connectivity for high-speed fully redundant RAID disk storage.

Editing bays provide backend support for the main rooms and can function independently if required for multiple projects. Each editing bay consists of a Protools 24|Mix plus system and appropriate out-board equipment. All Editing bays will be interconnected to the main rooms via Ethernet and to the central digital storage array via fiber optics. One bay will contain a system for Video editing.

### Recording Space, Foley Pit, Isolation Booths

A main recording room offers not only a large space for in-house recording, but also a small number of isolation booths for voice-over, ADR and a Foley pit. In one embodiment, the recording spaces are located adjacent and between the Main and Secondary suites, and are wired to all editing and mixing rooms within the facility.

### Location Audio Team

Each Site maintains and makes available a number of small Protools systems designed and implemented for outdoor, on-location recording. These systems will be equipped for Film, video and TV location sound. Each system will consist of a Protools 24 system providing at a minimum, 8 tracks of live recording with mix back to 2 channel or Mono on site. The systems will be configured with high-end A/D and D/A Converters, SMPTE and Video Sync capabilities, Fishpoles and a selection of microphone options. During and after shooting the Editing capability may be employed for sync and non-sync playback, location background sound playback, and general editing. Once a shot is “in the can” the data can be sent to the post facility a number of ways:

1. Removable disks can be delivered by courier to a system facility.

2. Removable disks may be sent over-night.

3. Data may be directly transmitted via DSL circuit or other high-speed Internet link to any post facility.

4. Data may be transmitted directly from on-site to the studio via wireless Data modems.

### Conference and Client Space

In an embodiment, each facility will house a fully functional and state-of-the art video conference center, again linked to all editing and mixing suites, as well as, all external telecommunication for video and teleconferences.

### Operations Facility

The operational area contains a central machine room for video and audio equipment, patchbays, out-board equipment and computer systems. Additionally, telecommunications systems and equipment will be housed in the machine spaces. A state-of-the-art fully redundant RAID based Digital storage system will provide project storage for all current and recent projects. All editing and mixing suites have a redundant fiber optic connection back to the central storage facility. Backups are on-line and performed automatically via both Disk duplication and external tape sub-systems. Back Office spaces are provided for operation, maintenance, duplication, storage and access to the cable plant.

An engineer in one facility may be assigned a fader or fader bank for audio processing from a console or tactile work surface to a similar device in a second facility, allowing a second person to modify the audio from the first facility by manipulating the local fader from the second facility. This capability will span

all network based consoles

all tactile work surfaces

all network based audio processing components with tactile network based work surfaces

The present invention may be implemented as on of the following site type: Core; extended, LR or SR.

### Base Level or Core

In one embodiment, a base level or CORE level facility offers 1 Main Mixing Studio, 2 edit rooms, 2 Vocal booth/Foley pits, 1 general used recording studio, and 1 machine room. Additionally, there may be other facilities co-located, such as offices, meeting rooms, kitchen, bathrooms, lounge, etc. These rooms provide a base of operations and support the technology required.

### Minimum Facility

A minimum facility offers at least 1 Edit room linked to the MATRIX.

### Extended Facility

An extended facility may offer any number of recording, editing, and mixing spaces, as long as the rooms associated meet the certification parameters and are in fact on-line to the MATRIX network.

### LR

LR provides for mobility. An LR facility consists of a Core site EDIT room configuration enclosed in an international standards short container. These sites may be located in any location for any time duration. Connectivity may be provided via Fiber, standard high-speed telecomm or satellite/cellular. Connectivity need not be made if the project is a standalone effort.

### SR

SR provides for mobility. An SR consists of a Protools DAW station built into a small ATA Flight case including any network equipment required to cellular/satellite communications to a Core Site. The SR may be located in any location for any time duration. This small mobile system allows for on-site recording/playback/editing and mixing for small jobs or on-location film efforts.

### Core

The core is based on a TCP/IP technology tactile mixing desk or other digital mixing console. Any digital console may be used within the system of the present invention that meets the standards set forth. The current core console is based on Digidesigns Procontrol, an IP based tactile mixing control surface that allows interaction of audio editing from the tactile interface to a local computer based TDM Audio Editing software platform. By combining these capabilities with multiple workstations and multiple tactile work surfaces located in any number of local rooms and then expanding this across the MATRIX the system provides a virtual facility allowing global audio realtime editing.

What is claimed is:

1. A plurality of audio spaces wherein said audio spaces each comprise
an identical acoustical enclosure;
an identical acoustical treatment to said enclosure;
interconnections for all necessary cabling to operate audio and video equipment within said enclosure.

2. The plurality of audio spaces of claim 1 further comprising:
interconnection between said audio spaces.

3. The plurality of audio spaces of claim 1 wherein each of said audio spaces further comprise:
a machine room;
multiple digital audio workstations (DAW);
multiple audio mixing consoles; and
multiple audio processors.

4. The plurlilty of audiospaces of claim 1 wherein each of said audio spaces has a Local Area Network to support interconnection and inter-communication between said audio spaces and DAWs.

5. A Local Area/Wide Area Network configured to provide high-speed thruput to accommodate audio and video data from a central content management system to any local DAW system or mixing console internally in a single facility and/or across a network to remote facilities.

6. The Local Area/Wide Area Network of claim 5 further comprising;
one or more fiber or other high-speed network based audio and video content servers;
redundant servers providing redundant data paths to all DAW systems (as required);
management console providing monitoring and management of all Servers on the network.

7. The Local Area/Wide Area Network of claim 5 further comprising;
a central storage apparatus capable of transmitting and duplicating local content across a Wide Area Network to similar Central Storage apparatus at other networked facilities.

8. An apparatus comprising a multiplexer/demultiplexer and/or a compression apparatus to encode and decode audio data streams sent externally from one facility to any or all other facilities as a point to point data stream.
